(19) United States
(12) Patent Application Publication
(10) Pub. No.: US 2026/0221818 A1
(43) Pub. Date: Jul. 30, 2026

(54) ROTATING ELECTRIC MACHINE SYSTEM

(71) Applicant: HONDA MOTOR CO., LTD., Tokyo (JP)

(72) Inventors: Motoshi Togasaki, Wako-shi (JP); Daijiro Eto, Wako-shi (JP); Yuki Wada, Wako-shi (JP); Kenta Yamazaki, Wako-shi (JP); Rintaro Tanaka, Wako-shi (JP); Keita Chinzaka, Wako-shi (JP)

(21) Appl. No.: 19/458,094

(22) Filed: Jan. 23, 2026

(30) Foreign Application Priority Data
Jan. 29, 2025 (JP) 2025-012853

(51) Int. Cl. H02K 1/16; H02K 1/20; H02K 5/16

(52) U.S. Cl. CPC H02K 1/16; H02K 1/20; H02K 5/161

(57) ABSTRACT

A stator core of a rotating electric machine system includes an annular portion that constitutes an outer circumferential part of the stator core, a tooth that projects out inwardly in a radial direction from the annular portion, and a gas supply path in order to supply a gas into an annular space that is formed between a rotor and a stator. An inlet of the gas supply path is disposed in the annular portion. An outlet of the gas supply path is disposed on an inner end of the tooth.

### CROSS-REFERENCE TO RELATED APPLICATIONS

This application is based upon and claims the benefit of priority from Japanese Patent Application No. 2025-012853 filed on January 29, 2025, the contents of which are incorporated herein by reference.

### BACKGROUND OF THE INVENTION

### Field of the Invention

The present disclosure relates to a rotating electric machine system.

### Description of the Related Art

In JP 2024-025367 A, a configuration for supplying a gas (air) into a housing of a rotating electric machine is disclosed. By supplying the gas, a lubricating oil is prevented from flowing into a space (an accommodation chamber) that accommodates a rotor and a stator in the rotating electric machine housing.

### SUMMARY OF THE INVENTION

It is desirable for the gas to be supplied in a well-balanced manner to each of the portions inside the rotating electric machine housing.

The present invention has the object of solving the aforementioned problem.

An aspect of the present disclosure is characterized by a rotating electric machine system including a rotating electric machine including a rotor and a stator, a rotating electric machine housing in which a rotating shaft of the rotor is supported in a rotatable manner, and a first bearing and a second bearing configured to be interposed between the rotating electric machine housing and the rotating shaft, and to be mutually spaced apart from each other in an axial direction of the rotor, wherein a stator core of the stator includes an annular portion configured to constitute an outer circumferential part of the stator core, a tooth configured to project out inwardly in a radial direction from the annular portion, and a gas supply path in order to supply a gas into an annular space formed between the rotor and the stator, an inlet of the gas supply path is disposed in the annular portion, and an outlet of the gas supply path is disposed on an inner end of the tooth.

According to the rotating electric machine system of the present disclosure, the gas passes through the gas supply path that is formed in the stator core, and is supplied from the inner end of the tooth to the annular space between the rotor and the stator. Therefore, compared to a configuration in which the gas is supplied to the interior of the rotating electric machine housing from a position that is separated in an axial direction away from the stator, a balanced supply of the gas to each of the respective parts inside the rotating electric machine housing can be achieved. By achieving such a balanced supply of the gas, it is possible to reduce the amount of the gas that is supplied.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a combined motive power system;

FIG. 2 is a schematic cross-sectional view of a rotating electric machine system;

FIG. 3 is a schematic cross-sectional view of the rotating electric machine system as viewed from another angle;

FIG. 4 is an enlarged cross-sectional view in the vicinity of a first bearing;

FIG. 5 is an enlarged cross-sectional view in the vicinity of a second bearing;

FIG. 6 is a schematic cross-sectional view of the rotating electric machine system;

FIG. 7 is an exploded perspective view of a stator core;

FIG. 8 is a schematic cross-sectional view of a rotating electric machine according to an exemplary modification; and

FIG. 9 is a conceptual diagram of an oil circulation supply device in the rotating electric machine system.

### DETAILED DESCRIPTION OF THE INVENTION

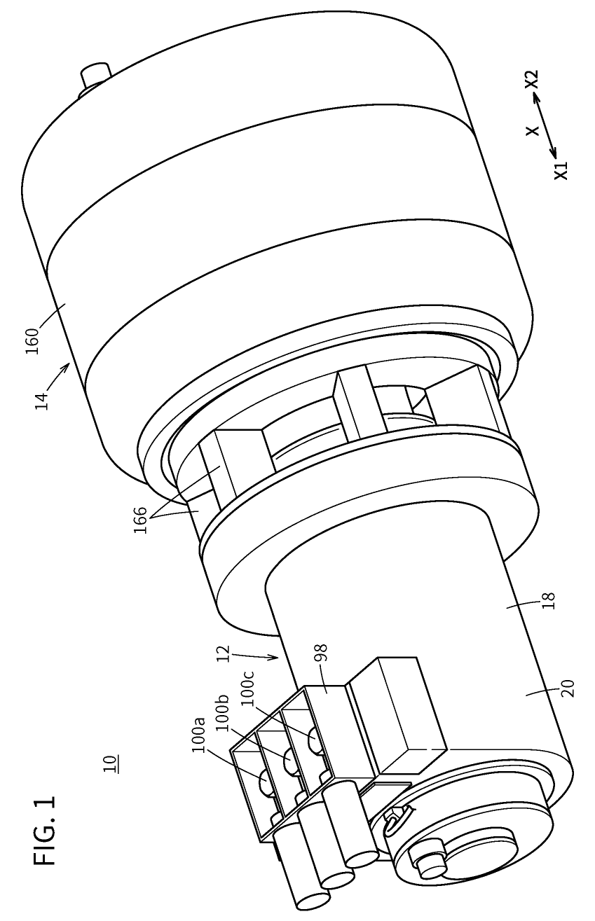

A combined motive power system 10 shown in FIG. 1 is equipped with a rotating electric machine system 12 according to the present embodiment, and a gas turbine engine 14. An axial line of the rotating electric machine system 12, and an axial line of the gas turbine engine 14 coincide with each other. Stated otherwise, the rotating electric machine system 12 and the gas turbine engine 14 are arranged in series on the same axial line.

The combined motive power system 10 is used, for example, as a motive power source for providing propulsion in a flying object, a ship, an automobile, or the like. Suitable specific examples of the flying object include drones and multi-copters. The combined motive power system 10, when mounted on a flying object, is used as a power drive source for rotationally driving, for example, a prop, a ducted fan, or the like. The combined motive power system 10, when mounted on a ship, is used as a rotational force generating device for a screw. The combined motive power system 10, when mounted on an automobile, is used as a power drive source for rotating a motor.

The combined motive power system 10 can also be used as an auxiliary electrical power source in an aircraft, a ship, a building, or the like. Apart therefrom, it is also possible to utilize the combined motive power system 10 as gas turbine power generation equipment. The gas turbine engine 14 is an internal combustion engine.

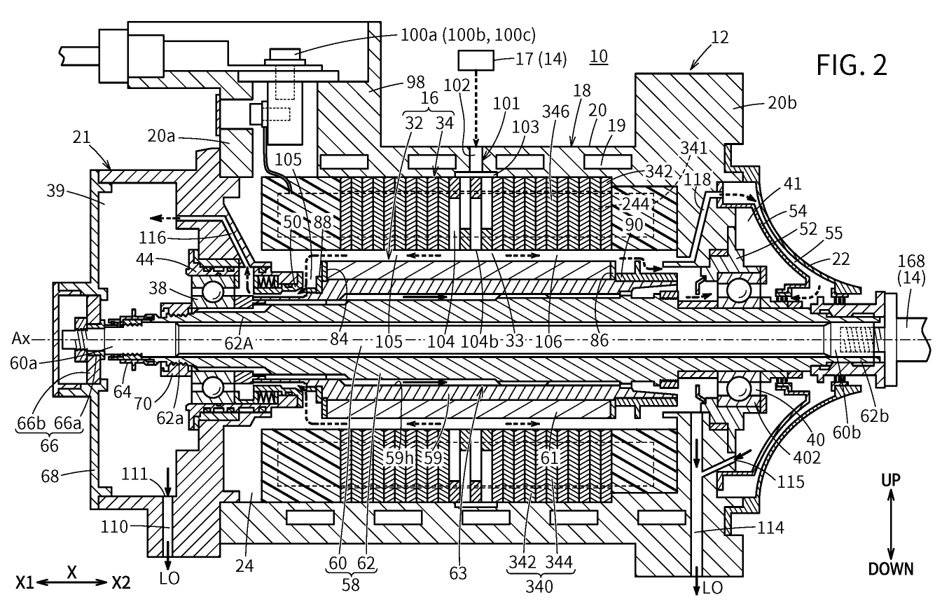

In the following description, the respective terms "lower" and "upper" refer specifically to the lower and the upper directions shown in FIG. 2.

As shown in FIG. 2, the rotating electric machine system 12 is equipped with a rotating electric machine 16, and a rotating electric machine housing 18. In the present embodiment, the rotating electric machine 16 is a generator. The rotating electric machine 16 includes a rotor 32 and a stator 34.

The rotating electric machine housing 18 accommodates the rotating electric machine 16. The rotating electric machine housing 18 includes a main housing 20, a first sub-housing 21, and a second sub-housing 22. The main housing 20 has a substantially cylindrical shape with both ends open. The main housing 20 includes an accommodation chamber that serves to accommodate the rotating electric machine 16. A cooling jacket 19 is formed in the interior of a circumferential wall part of the main housing 20. A liquid coolant such as cooling water or the like flows through the cooling jacket 19.

The first sub-housing 21 is connected to a first housing end 20a, which is an end part on a side in the X1 direction of the main housing 20, and thereby closes an opening of the first housing end 20a. The second sub-housing 22 is connected to a second housing end 20b, which is an end part on a side in the X2 direction of the main housing 20, and thereby closes an opening of the second housing end 20b.

The rotor 32 is supported via a first bearing 38 and a second bearing 40 to be capable of rotating with respect to the rotating electric machine housing 18. Next, a description will be given concerning the first bearing 38, the second bearing 40, and the surrounding structure thereof.

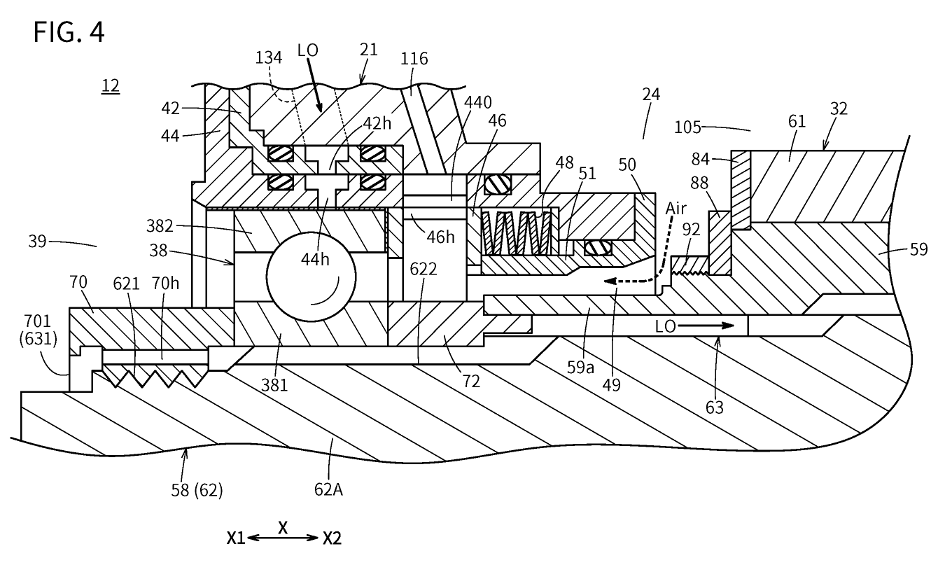

As shown in FIG. 4, a hollow cylindrically shaped holder spacer 42 and a hollow cylindrically shaped first bearing holder 44 are inserted into the inner circumferential part of the first sub-housing 21. The first bearing 38 is disposed on an inner side of the first bearing holder 44. A hollow portion of the first sub-housing 21 forms a first bearing chamber 39 in which the first bearing 38 is accommodated. A lubricating oil LO is supplied to the first bearing 38, via an oil supplying hole 42h that is formed in the holder spacer 42, and an oil supplying hole 44h that is formed in the first bearing holder 44.

The first bearing holder 44 includes a plurality of oil drainage holes 440. The plurality of oil drainage holes 440 are holes for the purpose of discharging the lubricating oil LO that was supplied to the first bearing 38 to the exterior of the first bearing holder 44.

A spacer ring 46 is fixed inside an interior of the first bearing holder 44. The spacer ring 46 includes a plurality of relay holes 46h. The plurality of relay holes 46h are formed at intervals in the circumferential direction of the spacer ring 46.

A preload applying member 48, via the spacer ring 46, applies a load (a preload) to an outer ring 382 of the first bearing 38. The direction of the load is in the axial direction (the X direction) of the rotor 32. The preload applying member 48 is constituted, for example, by a plurality of disc springs.

A holder member 50 is mounted on an end part on a side in the X2 direction of the first bearing holder 44. The holder member 50 is fixed to the first bearing holder 44, and therefore is a non-rotating part. The holder member 50 serves to retain the preload applying member 48. The holder member 50 includes a hollow cylindrically shaped holder cylinder part 51. The preload applying member 48 is disposed in an annular space that is formed between the first bearing holder 44 and the holder cylinder part 51.

As shown in FIG. 2, an annular shaped second bearing holder 52 is mounted on the second housing end 20b (an end part on a side in the X2 direction) of the main housing 20. The second bearing holder 52 is connected via bolts or the like to the main housing 20. An outer ring 402 of the second bearing 40 is retained on an inner circumferential part of the second bearing holder 52. A flow path forming member 54 is fixed to an end part on a side in the X2 direction of the main housing 20. The flow path forming member 54 covers the second bearing 40. A hollow portion of the flow path forming member 54 forms a second bearing chamber 41 in which the second bearing 40 is accommodated.

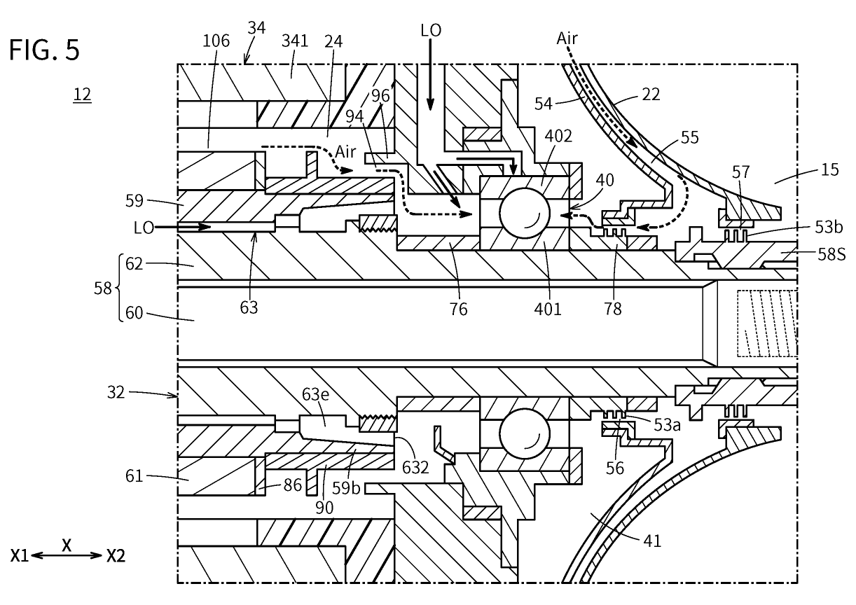

The rotor 32 includes a rotating shaft 58, a sleeve 59, and permanent magnets 61. The sleeve 59 surrounds the rotating shaft 58, and the permanent magnets 61 surround the sleeve 59. A rotor internal flow path 63 is formed in the rotor 32. According to the present embodiment, the lubricating oil LO flows as a liquid coolant through the rotor internal flow path 63. The lubricating oil LO flows through the rotor internal flow path 63 from an inlet 631 (refer to FIG. 4) toward an outlet 632 (refer to FIG. 5) of the rotor internal flow path 63. More specifically, the lubricating oil LO flows in the X2 direction through the rotor internal flow path 63. Therefore, concerning the rotor internal flow path 63, the side in the X1 direction is an upstream side, and the side in the X2 direction is a downstream side. The rotor internal flow path 63 gradually expands in diameter in a stepwise manner toward the downstream side.

The rotating shaft 58, together with being supported to be capable of rotating by the first sub-housing 21 via the first bearing 38, is supported to be capable of rotating by the main housing 20 via the second bearing 40. The rotating shaft 58 includes an inner shaft 60, and an outer shaft 62.

The inner shaft 60 includes a first inner shaft end 60a, which is an end part on a side in the X1 direction, and a second inner shaft end 60b, which is an end part on a side in the X2 direction. The outer shaft 62 includes a first outer shaft end 62a, which is an end part on a side in the X1 direction, and a second outer shaft end 62b, which is an end part on a side in the X2 direction. The inner shaft 60 is inserted into an inner part of the outer shaft 62. The inner shaft 60 is longer than the outer shaft 62.

The first inner shaft end 60a projects out in the X1 direction from the first outer shaft end 62a. The first inner shaft end 60a, by means of a fastening structure including a nut member 64 or the like, is connected to the first outer shaft end 62a.

A resolver rotor 66a is fixed to the first inner shaft end 60a. A resolver stator 66b is disposed in a manner so as to surround the resolver rotor 66a. The resolver stator 66b is retained by a resolver holder 68 that is attached to the first sub-housing 21. The resolver rotor 66a and the resolver stator 66b constitute a resolver 66.

The outer shaft 62 is a hollow cylindrical member. As shown in FIG. 4, the outer shaft 62 defines the rotor internal flow path 63 between a fastening ring 70, the first bearing 38, a support member 72, and the sleeve 59.

An inner ring 381 of the first bearing 38 is supported by a first shaft portion 62A that constitutes an end part on a side in the X1 direction of the outer shaft 62. An outer circumferential part of the first shaft portion 62A includes a male thread 621, and a plurality of flow path grooves 622.

The fastening ring 70 is screwed onto the male thread 621 of the first shaft portion 62A. The inner ring 381 of the first bearing 38 is sandwiched between the fastening ring 70 and the support member 72 in an axial direction (the X direction) of the rotor 32. The support member 72 is an inner ring stopper. In accordance with this feature, the inner ring 381 of the first bearing 38 is fixed to a predetermined location on the outer circumferential surface of the outer shaft 62.

The fastening ring 70 includes a plurality of communication holes 70h disposed mutually at intervals in the circumferential direction. The plurality of communication holes 70h penetrate in the axial direction through an inner circumferential part of the fastening ring 70. An annular opening 701 that is disposed on a side in the X1 direction of the fastening ring 70 serves as the inlet 631 of the rotor internal flow path 63. An end surface on a side in the X2 direction of the fastening ring 70 abuts against the inner ring 381 of the first bearing 38. The plurality of communication holes 70h constitute one part of the rotor internal flow path 63.

The plurality of flow path grooves 622 are disposed more on a downstream side than the plurality of communication holes 70h that are formed in the fastening ring 70. The plurality of flow path grooves 622 are formed mutually at intervals from one another in the circumferential direction of the outer shaft 62. Each of the flow path grooves 622 is recessed inwardly in a radial direction from the outer circumferential surface of the outer shaft 62, and extends in the axial direction of the rotor 32. The plurality of flow path grooves 622 constitute one part of the rotor internal flow path 63. The inner ring 381 of the first bearing 38 is disposed in a manner so as to surround the plurality of flow path grooves 622.

The support member 72 is an annular portion that is disposed between the inner ring 381 of the first bearing 38 and the sleeve 59. A part of the rotor internal flow path 63 is formed between the outer shaft 62 and the support member 72. The support member 72 is fixed to the outer shaft 62, for example, by press fitting. The support member 72 is supported by an outer circumferential part of the outer shaft 62. The support member 72 is disposed in a manner so as to surround the plurality of flow path grooves 622. The support member 72 lies adjacent to the inner ring 381 of the first bearing 38, and further, supports a first sleeve end part 59a which is one end part of the sleeve 59. A part of the rotor internal flow path 63 is formed between the outer shaft 62 and the sleeve 59.

As shown in FIG. 5, an outlet space 63e of the rotor internal flow path 63 is formed between the outer shaft 62 and a second sleeve end part 59b.

An inner side inner ring stopper 76, an inner ring 401 of the second bearing 40, and an outer side inner ring stopper 78 are supported by an outer circumferential surface of the outer shaft 62. The inner ring 401 of the second bearing 40 is sandwiched from both sides in the axial direction between the inner side inner ring stopper 76 and the outer side inner ring stopper 78. In accordance with this feature, the inner ring 401 of the second bearing 40 is fixed to a predetermined location on the outer circumferential surface of the outer shaft 62.

As shown in FIG. 2, the sleeve 59 is a hollow cylindrical member having an inner hole 59h. The rotating shaft 58 is inserted into the inner hole 59h of the sleeve 59. A major portion of the rotor internal flow path 63 is formed by the sleeve 59 and the rotating shaft 58. The sleeve 59 surrounds the rotating shaft 58.

As shown in FIG. 4, the holder member 50 is a hollow tubular shaped portion that is disposed outwardly in the radial direction of the first sleeve end part 59a. A gap is formed between the first sleeve end part 59a and the holder member 50 (the holder cylinder part 51). The preload applying member 48 is disposed in a manner so as to surround the holder member 50 and the support member 72. The first sleeve end part 59a is inserted on an inner side of the holder member 50. An annular gap 49 is formed between the first sleeve end part 59a and the holder member 50.

The sleeve 59 is fixed, for example, by shrink fitting, to an outer surface of the rotating shaft 58. The permanent magnets 61 are retained in the sleeve 59. In the present aspect, the rotor 32 is a so-called SPM (surface permanent magnet motor) type in which the permanent magnets 61 are disposed on an outer circumferential surface of the sleeve 59. Alternatively, the rotor 32 may be of a so-called IPM (interior permanent magnet motor) type in which the permanent magnets 61 are embedded in the sleeve 59.

As shown in FIG. 2, a first ring body 84 abuts against end surfaces of the permanent magnets 61 on a side in the X1 direction. A second ring body 86 abuts against end surfaces of the permanent magnets 61 on a side in the X2 direction. The first ring body 84, the permanent magnets 61, and the second ring body 86 are sandwiched between a pair of magnet stoppers 88 and 90 in the axial direction of the rotor 32. Hereinafter, the magnet stopper 88 on the side in the X1 direction will be referred to as a "first magnet stopper 88," and the magnet stopper 90 on the side in the X2 direction will be referred to as a "second magnet stopper 90."

The first magnet stopper 88 is fixed by a fixing ring 92 (refer to FIG. 4) that is screwed onto the sleeve 59. The second magnet stopper 90 is fixed to the second sleeve end part 59b (refer to FIG. 5). The second sleeve end part 59b is another end part in the axial direction of the sleeve 59. The first magnet stopper 88 and the second magnet stopper 90 are fixed, for example, by shrink fitting, to an outer circumferential part of the sleeve 59. In accordance with this feature, the permanent magnets 61 are fixed to the outer circumferential surface of the sleeve 59.

As shown in FIG. 5, an annular gap 94 is formed between the second magnet stopper 90 and an annular protrusion 96 that is disposed on the main housing 20. The second sleeve end part 59b forms the outlet space 63e of the rotor internal flow path 63 between itself and the outer shaft 62. An inner diameter of the second sleeve end part 59b becomes larger toward the X2 direction. A downstream end of the outlet space 63e (an opening on a side in the X2 direction of the sleeve 59 ) is the outlet 632 of the rotor internal flow path 63.

As shown in FIG. 2, the stator 34 includes a stator core 340, and a plurality of electromagnetic coils 341. The stator core 340 is a tubular shaped member. The stator core 340 is constituted by stacking in the axial direction a plurality of plate members 346 made of ring shaped electromagnetic steel plates.

The stator core 340 includes an annular portion 342, and a plurality of teeth 344. The annular portion 342 forms an outer circumferential part of the stator core 340. The plurality of teeth 344 project out inwardly in a radial direction from the annular portion 342. More specifically, the plurality of teeth 344 project out from the annular portion 342 toward the rotor 32. The plurality of teeth 344 are spaced at equal intervals in the circumferential direction of the stator 34.

The plurality of electromagnetic coils 341 are inserted into a plurality of slots that are formed between the plurality of teeth. The plurality of electromagnetic coils 341 include a U-phase coil, a V-phase coil, and a W-phase coil. Therefore, in the case that the rotating electric machine 16 is a generator, the rotating electric machine 16 is a so-called three-phase electrical power source. Each of the plurality of electromagnetic coils 341 is constituted by winding a conductive wire around the tooth or teeth of the stator core 340.

As shown in FIG. 1, a terminal casing 98 is integrally provided on an upper surface on a side in the X1 direction of the main housing 20. As shown in FIG. 2, a U-phase terminal 100a, a V-phase terminal 100b, and a W-phase terminal 100c are accommodated inside the terminal casing 98. The U-phase terminal 100a, the V-phase terminal 100b, and the W-phase terminal 100c are electrically connected respectively to the U-phase coil, the V-phase coil, and the W-phase coil of the stator 34.

As shown in FIG. 2, a gaseous coolant flow path structure 101 is provided in the rotating electric machine system 12. The gaseous coolant flow path structure 101 is a structure for the purpose of circulating a gas via the rotor 32 (particularly, the permanent magnets 61) and the stator 34. At this time, the rotor 32 and the stator 34 are capable of being cooled by a cooling gas. In the following description, air will be illustrated as an example of the cooling gas. The air is supplied from a gas supply device 17. Moreover, as will be discussed later, the air that is supplied to the rotating electric machine housing 18 forms an air curtain in order to prevent the lubricating oil LO from entering into an accommodation chamber 24. Therefore, the gaseous coolant flow path structure 101 also serves in a dual manner as a sealing air flow path structure.

The gaseous coolant flow path structure 101 includes a gas introduction path 102, a circumferential distribution path 103, a gas supply path 104, a first branching path 105, and a second branching path 106.

The gas introduction path 102 is formed in the main housing 20. An air supply port, which serves as the inlet of the gas introduction path 102, is disposed on the outer surface of the main housing 20. The gas introduction path 102 extends toward the stator 34. The circumferential distribution path 103 communicates with the gas introduction path 102 at a location inwardly in the radial direction of the gas introduction path 102. According to the present embodiment, the circumferential distribution path 103 is an annular groove that is formed on an inner circumferential part of the main housing 20. The circumferential distribution path 103 extends along the circumferential direction of the main housing 20, surrounds the rotor 32, and makes a full circle around an axis of rotation Ax.

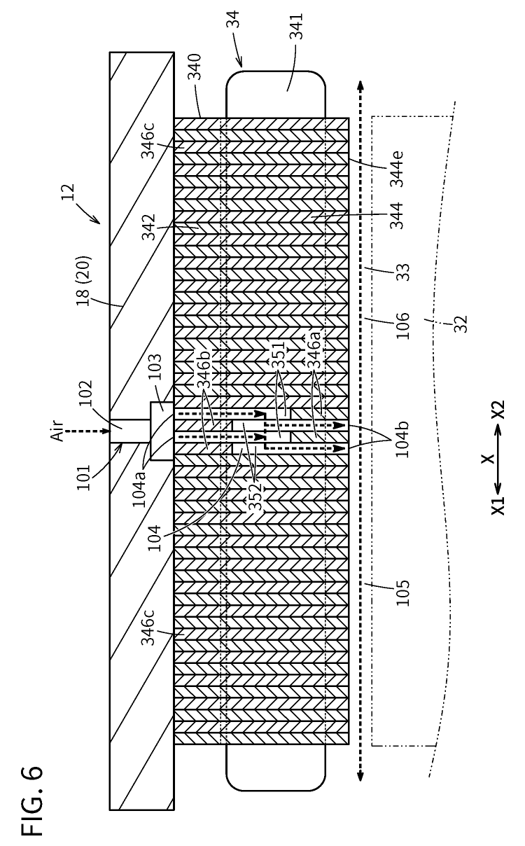

As shown in FIG. 6, the gas supply path 104 is formed in the stator core 340. The gas supply path 104 is a path for the purpose of supplying air to an annular space 33 formed between the rotor 32 and the stator 34. Therefore, the gas supply path 104 communicates with the annular space 33. An inlet 104a, which is an upstream end of the gas supply path 104, is disposed in the annular portion 342. An outlet 104b, which is a downstream end of the gas supply path 104, is disposed on an inner end 344e (a protruding end) of the tooth 344. The inner end 344e of the tooth 344 is an end surface of the tooth 344 that faces toward an outer circumferential surface of the rotor 32 . Therefore, the outlet 104b of the gas supply path 104 faces toward the outer circumferential surface of the rotor 32.

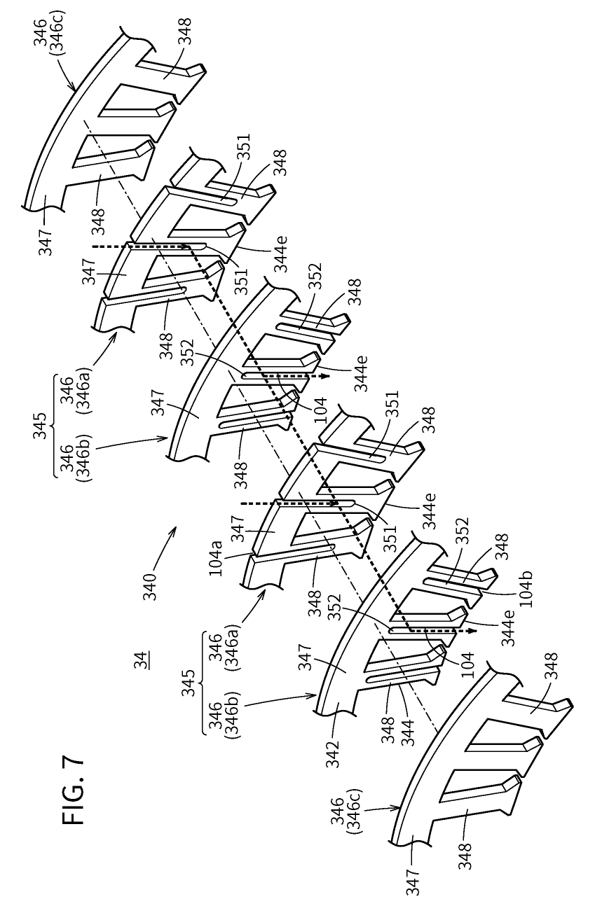

As shown in FIG. 7, each of the plurality of the plate members 346 that constitute the stator core 340 includes an outer circumferential edge part 347, and a plurality of rod shaped portions 348. The plurality of outer circumferential edge parts 347, by being stacked in the axial direction, form the annular portion 342 of the stator core 340. Each of the teeth 344 of the stator core 340 is constituted by stacking the plurality of rod shaped portions 348.

The plurality of the plate members 346 include at least one first plate member 346a, at least one second plate member 346b, and at least one third plate member 346c. According to the present embodiment, a plurality of individual first plate members 346a, a plurality of individual second plate members 346b, and a plurality of individual third plate members 346c are provided, respectively. The first plate members 346a, the second plate members 346b, and the third plate members 346c have mutually different shapes from each other. When a combination of one of the first plate members 346a and one of the second plate members 346b that are adjacent to each other is defined as one set of composite plate units 345, the stator core 340 has a plurality of sets of the composite plate units 345. The plurality of composite plate units 345 are stacked in the axial direction. Three or more sets of the composite plate units 345 may be provided.

Moreover, the gas supply path 104 may be formed by stacking a first plate unit that is constituted by stacking a plurality of the first plate members 346a in succession, and a second plate unit that is formed by stacking a plurality of the second plate members 346b in succession in the axial direction. For example, the gas supply path 104 can be formed using a first plate unit that is formed by stacking in succession two of the first plate members 346a, and a second plate unit that is formed by stacking in succession two of the second plate members 346b.

A first groove portion 351 that constitutes one part of the gas supply path 104 is formed in the first plate member 346a. The first groove portion 351 includes the inlet 104a. The first groove portion 351 penetrates in a plate thickness direction (an axial direction) through the first plate member 346a. The first groove portion 351 extends inwardly in a radial direction from an outer circumferential surface of the first plate member 346a, penetrates in a radial direction through the outer circumferential edge part 347, and extends to the rod shaped portion 348. An inner end of the first groove portion 351 is positioned in the rod shaped portion 348. Therefore, the inner end of the first groove portion 351 is positioned more inwardly in a radial direction than an outer end of the rod shaped portion 348. The inner end of the first groove portion 351 does not reach to the inner end 344e of the tooth 344. Therefore, the first groove portion 351 does not penetrate in the radial direction through the first plate member 346a. The first plate member 346a is an annular member that is connected seamlessly around the entire circumference.

In each of the first plate members 346a, a plurality of the first groove portions 351 are disposed mutually at intervals from one another in the circumferential direction of the stator 34. In each of the first plate members 346a, the first groove portions 351 are disposed in a plurality corresponding to the number of the individual rod shaped portions 348 that are provided in each of the first plate members 346a. Therefore, in each of the first plate members 346a, the number of the individual first groove portions 351 and the number of the individual rod shaped portions 348 are the same. Moreover, in each of the first plate members 346a, the number of the individual first groove portions 351 may be less than the number of the individual rod shaped portions 348.

A second groove portion 352 that constitutes one part of the gas supply path 104 is formed in the second plate member 346b. The second groove portion 352 includes the outlet 104b. The second groove portion 352 penetrates in a plate thickness direction (an axial direction) through the second plate member 346b. The second groove portion 352 extends outwardly in a radial direction from the inner end 344e of the tooth 344. The outer end of the second groove portion 352 does not reach to the outer circumferential surface of the outer circumferential edge part 347. Therefore, the second groove portion 352 does not penetrate in the radial direction through the second plate member 346b. The second plate member 346b is an annular member that is connected seamlessly around the entire circumference.

In each of the second plate members 346b, a plurality of the second groove portions 352 are disposed mutually at intervals from one another in the circumferential direction of the stator 34. In each of the second plate members 346b, the second groove portions 352 are disposed in a plurality corresponding to the number of the individual rod shaped portions 348 that are provided in each of the second plate members 346b. Therefore, in each of the second plate members 346b, the number of the individual second groove portions 352 and the number of the individual rod shaped portions 348 are the same. Moreover, in each of the second plate members 346b, the number of the individual second groove portions 352 may be less than the number of the individual rod shaped portions 348.

An outer end of the second groove portion 352 is positioned more outwardly in the radial direction than the inner end of the first groove portion 351. Therefore, the first groove portion 351 and the second groove portion 352 that are adjacent to each other and are provided respectively in the first plate member 346a and the second plate member 346b are in communication mutually with each other. Further, the first groove portions 351 of the plurality of first plate members 346a communicate mutually with each other via the second groove portion 352 of the second plate member 346b that is disposed between the plurality of first plate members 346a. The second groove portions 352 of the plurality of second plate members 346b communicate mutually with each other via the first groove portion 351 of the first plate member 346a that is disposed between the plurality of second plate members 346b.

The first plate members 346a and the second plate members 346b need not necessarily be directly adjacent to each other. A fourth plate member that does not include the first groove portion 351 and the second groove portion 352, and further, includes a through hole, may be disposed between the first plate members 346a and the second plate members 346b, and the first groove portion 351 and the second groove portion 352 may be connected via the through hole.

The third plate member 346c is a plate member in which the first groove portion 351 and the second groove portion 352 are not provided. As shown in FIG. 6, by the first plate member 346a, the second plate member 346b, and the third plate member 346c being stacked in the axial direction, the gas supply path 104 is disposed in only a partial region of the stator core 340 in the axial direction. When the stator core 340 is divided into three equal regions in the axial direction, which are designated as a first region, a second region (a central region), and a third region in the X2 direction, in the present embodiment, the gas supply path 104 is disposed in the second region. In the case that it is preferable to balance the amount of air that is supplied to each of the respective parts in the rotating electric machine housing 18, the gas supply path 104 may be disposed in the first region or the second region.

According to the present embodiment, the number of the third plate members 346c is greater than the total number of the first plate members 346a and the second plate members 346b. The ratio of the total number of the first plate members 346a and the second plate members 346b with respect to the total number of the plate members 346, for example, is 1 % to 10 %.

As shown in FIG. 7, each of the first groove portions 351 and the second groove portions 352 are disposed in a plurality mutually at intervals from one another in the circumferential direction of the stator 34. Therefore, the gas supply path 104 is disposed in a plurality mutually at intervals from one another in the circumferential direction of the stator 34.

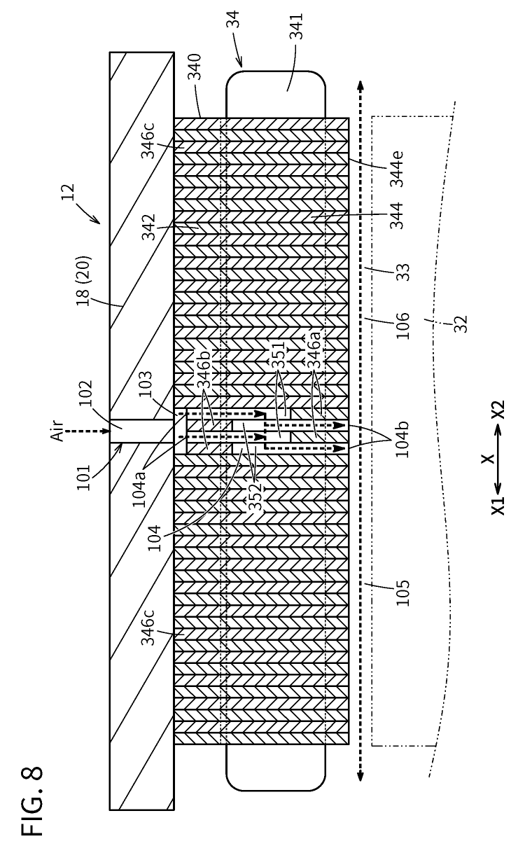

Moreover, as shown in FIG. 8, the circumferential distribution path 103, instead of being a groove that is disposed on an inner circumferential part of the main housing 20, may be a groove that is disposed on an outer circumferential part of the stator core 340. In FIG. 8, the outer diameter of the first plate members 346a and the second plate members 346b is smaller than the outer diameter of the third plate members 346c. Due to such a difference in the outer diameter, the circumferential distribution path 103 is formed on the outer circumferential part of the stator core 340.

In FIG. 2, the air that has passed through the gas supply path 104 and has flowed into the annular space 33 is divided into the first branching path 105 and the second branching path 106. The first branching path 105, within the annular space 33, is a flow path that faces toward the X1 direction from the outlet 104b of the gas supply path 104. The second branching path 106, within the annular space 33, is a flow path that faces toward the X2 direction from the outlet 104b of the gas supply path 104. More specifically, each of the first branching path 105 and the second branching path 106 is one part of the annular space 33.

The first branching path 105 is a flow path that directs the air toward the first bearing 38. As shown in FIG. 4, the air that has passed through the first branching path 105 flows into the annular gap 49 that is formed between the holder member 50 and the sleeve 59, and flows in the X1 direction through this annular gap 49. In this manner, the air that flows toward the first bearing 38 forms an air curtain. The air curtain prevents the lubricating oil LO from entering into the accommodation chamber 24 in which the rotor 32 is accommodated. Thereafter, via the relay holes 46h that are provided in the spacer ring 46, the air flows into a flow path 116 that is formed in the first sub-housing 21. As shown in FIG. 2, the air that has passed through the flow path 116 flows into the first bearing chamber 39 which is a hollow portion of the first sub-housing 21. Between the first bearing chamber 39 and the accommodation chamber 24 (the annular gap 49 shown in FIG. 4), a sealing structure (such as a labyrinth seal or the like) is not provided in order to prevent inflowing of the lubricating oil LO from the first bearing chamber 39 into the accommodation chamber 24.

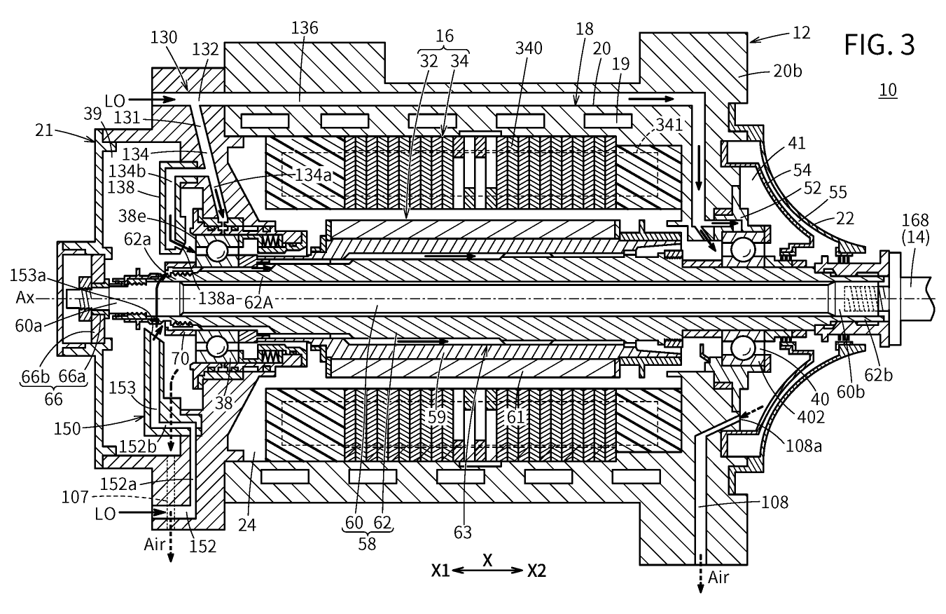

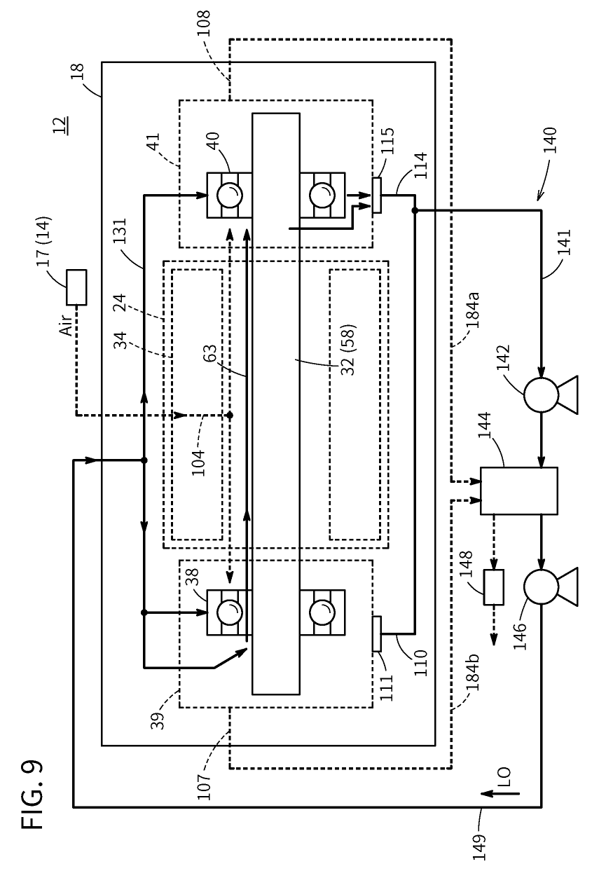

As shown in FIG. 3, the air is discharged, via a gas discharge path 107 (hereinafter referred to as a "first gas discharge path 107"), from the first bearing chamber 39. The first gas discharge path 107 is formed in the first sub-housing 21. The air that is discharged via the first gas discharge path 107 is introduced into a tank 144 (refer to FIG. 9).

As shown in FIG. 2, the second branching path 106 is a clearance that extends along the axial direction of the rotor 32 between the rotor 32 and the stator 34. The second branching path 106 is a flow path that directs the air toward the second bearing 40. As shown in FIG. 5, a portion of the air that has passed through the second branching path 106 flows into an outer circumference side of the inner side inner ring stopper 76, and flows toward the second bearing 40. In this manner, the air that flows toward the second bearing 40 forms an air curtain. The air curtain prevents the lubricating oil LO from entering into the accommodation chamber 24 in which the rotor 32 is accommodated. Moreover, between the second bearing chamber 41 and the accommodation chamber 24 (the annular gap 94 between the second magnet stopper 90 and the annular protrusion 96 shown in FIG. 5), a sealing structure (such as a labyrinth seal or the like) is not provided in order to prevent inflowing of the lubricating oil LO from the second bearing chamber 41 into the accommodation chamber 24.

As shown in FIG. 2, the remainder of the air that has passed through the second branching path 106 flows into an air distribution path 118 that is formed in the main housing 20. The air that has passed through the air distribution path 118 flows into a flow path 55 that is formed between the second sub-housing 22 and the flow path forming member 54. An outer circumferential part of the flow path forming member 54 is fixed to the main housing 20 on an inner side of the second sub-housing 22.

As shown in FIG. 5, an annular ventilation path 56 is formed between an inner circumferential path of the flow path forming member 54 and an outer circumferential path of the outer side inner ring stopper 78. A first sealing structure 53a is disposed in the ventilation path 56. The first sealing structure 53a, for example, is a labyrinth seal. Further, a second sealing structure 53b is disposed in an annular shaped ventilation path 57 that is formed between the second sub-housing 22 and the rotating shaft 58 (a tubular member 58S). The second sealing structure 53b, for example, is a labyrinth seal.

The air that has passed through the flow path 55 branches into the X1 direction and the X2 direction. The air that is branched in the X1 direction flows, via the ventilation path 56, into the second bearing chamber 41, and flows toward the second bearing 40. The air that is branched in the X2 direction travels via the ventilation path 57 toward an intake path 15. The intake path 15 is a flow path for the purpose of introducing outside air into a compressor provided in the gas turbine engine 14.

As shown in FIG. 3, the air is discharged, via a gas discharge path 108 (hereinafter referred to as a "second gas discharge path 108") that is formed in the rotating electric machine housing 18, from the second bearing chamber 41. The gas inlet (a second vent opening 108a) of the second gas discharge path 108 is formed in an upper part of the second bearing chamber 41. Moreover, concerning the term "upper part" of the second bearing chamber 41, the term signifies a region of the second bearing chamber 41 that is more upward than the axis of rotation Ax of the rotating electric machine system 12. Accordingly, the second vent opening 108a may be formed more downward than an uppermost part of the second bearing chamber 41. The air that is discharged via the second gas discharge path 108 is introduced into the tank 144 (refer to FIG. 9).

As shown in FIG. 3, a lubricating oil flow path structure 130 and a rotor cooling structure 150 are further provided in the rotating electric machine system 12. The lubricating oil flow path structure 130 is a flow path in order to circulate and supply the lubricating oil LO to the first bearing 38 and the second bearing 40.

The lubricating oil flow path structure 130 includes a lubricating oil introduction path 132, a first distribution path 134, a first drain path 110 (FIG. 2), a second distribution path 136, and a second drain path 114 (FIG. 2). The lubricating oil introduction path 132, the first distribution path 134, and the second distribution path 136 make up an oil supply path 131 that is disposed in the rotating electric machine housing 18. The lubricating oil LO is supplied from an oil circulation supply device 140 (FIG. 9) to the lubricating oil introduction path 132. The lubricating oil introduction path 132, in the interior of the first sub-housing 21, branches into the first distribution path 134 and the second distribution path 136.

The first distribution path 134 is formed in the first sub-housing 21. The lubricating oil LO is supplied via the first distribution path 134 to the first bearing 38. The first distribution path 134 includes a first line 134a and a second line 134b. The first line 134a is a flow path through which the lubricating oil LO is supplied toward an outer circumferential part of the first bearing 38. The second line 134b is a flow path through which the lubricating oil LO is supplied toward an end surface 38e on a side in the X1 direction of the first bearing 38.

The second line 134b is formed in a first oil nozzle 138. The first oil nozzle 138 is fixed to the first sub-housing 21, and is disposed within the first bearing chamber 39. One end part of the first oil nozzle 138 is fixed to the first sub-housing 21. The first oil nozzle 138 extends toward the rotor 32. A first discharge port 138a that discharges the lubricating oil LO toward the end surface 38e of the first bearing 38 is disposed on another end of the first oil nozzle 138. The first discharge port 138a, in the vicinity of the end surface 38e of the first bearing 38, faces toward the end surface 38e.

As shown in FIG. 2, the lubricating oil LO that is supplied to the first bearing 38 is discharged from the first bearing chamber 39 via the first drain path 110 that is formed in the rotating electric machine housing 18. An upstream end of the first drain path 110 is an oil discharge port 111 (hereinafter referred to as a "first oil discharge port 111") that discharges the lubricating oil LO from the first bearing chamber 39. The first oil discharge port 111 is disposed on a lower part of the first bearing chamber 39. The first oil discharge port 111 may be disposed in any position that enables the discharge port to draw in the lubricating oil LO that is stored in the first bearing chamber 39. Therefore, the first oil discharge port 111 need not necessarily be the lowermost part of the first bearing chamber 39.

Moreover, as noted previously, an air curtain is formed in the vicinity of the first bearing 38. Therefore, a situation is suppressed in which the lubricating oil LO that is supplied to the first bearing 38 enters via the annular gap 49 (refer to FIG. 4) into the accommodation chamber 24.

As shown in FIG. 3, the second distribution path 136 of the lubricating oil flow path structure 130 is formed in the main housing 20. The lubricating oil LO is supplied via the second distribution path 136 to the second bearing 40. The lubricating oil LO that is supplied to the second bearing 40 is discharged from the second bearing chamber 41 via the second drain path 114 (refer to FIG. 2) that is formed in the rotating electric machine housing 18.

As shown in FIG. 2, an upstream end of the second drain path 114 is an oil discharge port 115 (hereinafter referred to as a "second oil discharge port 115") that discharges the lubricating oil LO from the second bearing chamber 41. The second oil discharge port 115 is disposed on a lower part of the second bearing chamber 41. The second oil discharge port 115 may be disposed in any position that enables the discharge port to draw in the lubricating oil LO that is stored in the second bearing chamber 41. Therefore, the second oil discharge port 115 need not necessarily be the lowermost part of the second bearing chamber 41.

Moreover, as noted previously, an air curtain is formed in the vicinity of the second bearing 40. Therefore, a situation is suppressed in which the lubricating oil LO that is supplied to the second bearing 40 enters into the accommodation chamber 24.

As shown in FIG. 3, the rotor cooling structure 150 is a flow path in order to supply the lubricating oil LO into the rotor 32, and thereby cool the permanent magnets 61. The rotor cooling structure 150 includes a supply path 152, the aforementioned rotor internal flow path 63, and the second drain path 114 (FIG. 2). The supply path 152 supplies the lubricating oil LO to the rotor internal flow path 63. The supply path 152 has an introduction path 152a that is formed in the first sub-housing 21, and a guide path 152b that is formed in a second oil nozzle 153.

The guide path 152b communicates with the introduction path 152a. The second oil nozzle 153 is disposed in the first bearing chamber 39. One end of the second oil nozzle 153 is fixed to the first sub-housing 21. The second oil nozzle 153 extends toward the rotor 32. A second discharge port 153a, which is an outlet of the guide path 152b, is formed in another end of the second oil nozzle 153. The second discharge port 153a, in the vicinity of the inlet 631 (refer to FIG. 4) of the rotor internal flow path 63, faces toward the inlet 631. The lubricating oil LO that is discharged from the second discharge port 153a, as shown in FIG. 4, flows via the annular opening 701 (the inlet 631) of the fastening ring 70 into the rotor internal flow path 63.

As shown in FIG. 9, the oil circulation supply device 140 is further provided in the rotating electric machine system 12. The oil circulation supply device 140, together with recovering the lubricating oil LO from the first bearing chamber 39 and the second bearing chamber 41, supplies the lubricating oil LO to the oil supply path 131 that is provided in the rotating electric machine housing 18. The oil circulation supply device 140 is equipped with a recovery pump 142, the tank 144, a supply pump 146, and a gas-liquid separator 148. By driving the recovery pump 142, the lubricating oil LO is drawn in, via the first drain path 110 and the second drain path 114, from the first bearing chamber 39 and the second bearing chamber 41. The lubricating oil LO that is drawn in flows via a recovery line 141 into the tank 144.

The tank 144 stores the lubricating oil LO that is discharged (recovered) from the first bearing chamber 39 and the second bearing chamber 41. Further, the air that is discharged from the first bearing chamber 39 and the second bearing chamber 41 is introduced into the tank 144 via the first gas discharge path 107 and the second gas discharge path 108. The air that is discharged from the first bearing chamber 39 and the second bearing chamber 41 is a gas-liquid mixture fluid that contains the lubricating oil LO in a mist like form. Therefore, the gas-liquid mixture fluid that has flowed into the tank 144 is separated into a gas and a liquid in the tank 144. More specifically, the tank 144 has a gas-liquid separation function. The air is discharged from the tank 144, and is introduced into the gas-liquid separator 148. Furthermore, after the gas-liquid separation has been completed in the gas-liquid separator 148, the air is released into the atmosphere.

The supply pump 146 draws in the lubricating oil LO from the tank 144, and supplies the lubricating oil LO via a supply line 149 to the oil supply path 131 of the rotating electric machine housing 18. In this manner, the oil circulation supply device 140, together with supplying the lubricating oil LO to the oil supply path 131 of the rotating electric machine housing 18, carries out an oil circulation operation to recover the lubricating oil LO from the rotating electric machine housing 18, and to supply the lubricating oil LO again to the oil supply path 131.

Next, a description will be given concerning the gas turbine engine 14 shown in FIG. 1. Moreover, it should be noted that the configuration of the gas turbine engine 14, for example, is similar to the configuration shown in FIG. 7 of JP 2023-106078 A. Therefore, the description of the gas turbine engine 14 will be kept brief.

The gas turbine engine 14 is equipped with an engine housing 160. The engine housing 160 is connected to the rotating electric machine housing 18. The engine housing 160 includes a plurality of leg members 166. An air intake space is formed between the leg members 166.

As shown in FIG. 2, the gas turbine engine 14 is equipped with an output shaft 168. A non-illustrated compressor wheel and a non-illustrated turbine wheel are mounted in a diametrical outward direction of the output shaft 168. The output shaft 168 is connected to the rotating shaft 58. The compressor wheel and the turbine wheel are capable of rotating integrally together with the rotating shaft 58 and the output shaft 168.

The gas turbine engine 14 may be a gas supply device 17 that supplies the air to the gaseous coolant flow path structure 101 (the sealing air flow path structure). In this case, a portion of the air that is generated by the rotation of the compressor wheel is extracted, and is supplied to the gas supply path 104. Moreover, the gas supply device 17 may be another compressor that compresses the atmosphere and supplies the same to the gas supply path 104. The cooling gas that is supplied to the gas supply path 104 may be a gas that is supplied from an oxygen cylinder, a nitrogen cylinder, or the like.

The combined motive power system 10 that is constituted as described above operates in the following manner.

First, by driving the rotating electric machine 16, the gas turbine engine 14 is started. When the gas turbine engine 14 starts, the rotor 32 of the rotating electric machine 16 rotates due to the rotational driving force of the output shaft 168 of the gas turbine engine 14, and electricity is generated in the rotating electric machine 16. In accordance with this feature, the combined motive power system 10 is placed in operation.

As shown in FIG. 9, during the operation of the combined motive power system 10, the air is supplied from the gas supply device 17 to the rotating electric machine housing 18. In accordance with this feature, the rotating electric machine 16, together with being cooled, is sealed by the air curtain. In this case, as shown in FIG. 6, the air flows via the gas introduction path 102 into the circumferential distribution path 103. The air that has flowed into the annular shaped circumferential distribution path 103 flows in the circumferential direction, and thereby the air is distributed to the gas supply path 104 that is provided at intervals in the circumferential direction. The air flows in this order through the first groove portion 351 and the second groove portion 352 of the gas supply path 104, flows from the outlet 104b, and flows into the annular space 33 that is formed between the rotor 32 and the stator 34. The air that has flowed into the annular space 33 is distributed in the X1 direction and the X2 direction.

Further, the lubricating oil LO is supplied from the oil circulation supply device 140 to the oil supply path 131 of the rotating electric machine housing 18, and the lubricating oil LO is supplied to the first bearing 38 and the second bearing 40. In this case, as shown in FIG. 3, the first oil nozzle 138 discharges the lubricating oil LO toward the first bearing 38.

The lubricating oil LO is supplied from the oil circulation supply device 140 to the second oil nozzle 153, and the lubricating oil LO is discharged from the second oil nozzle 153 toward the rotor 32 (the inlet 631 of the rotor internal flow path 63). In accordance with this feature, the permanent magnets 61 are cooled by the lubricating oil LO that flows through the rotor internal flow path 63.

In this manner, the lubricating oil LO is discharged from the first oil nozzle 138 toward the first bearing 38, and the lubricating oil LO is discharged from the second oil nozzle 153 toward the rotor 32. In this case, a portion of the lubricating oil LO is repelled by the rotor 32 and the first bearing 38 that are rotating at a high speed, and by gravity, reaches the oil reservoir region that is disposed on a lower part of the first bearing chamber 39. The lubricating oil LO is drawn in by the first oil discharge port 111, and is discharged from the first bearing chamber 39. The lubricating oil LO that has served to lubricate the second bearing 40 in the second bearing chamber 41 is drawn in by the second oil discharge port 115, and is discharged from the second bearing chamber 41.

On the other hand, as shown in FIG. 9, the air is discharged, via the first gas discharge path 107, from the first bearing chamber 39. In this manner, the fluid inside the first bearing chamber 39 is separated into the lubricating oil LO and the air, and each of the lubricating oil LO and the air is discharged from the first bearing chamber 39. Further, the air is discharged, via the second gas discharge path 108, from the second bearing chamber 41. In this manner, the fluid inside the second bearing chamber 41 is separated into the lubricating oil LO and the air, and each of the lubricating oil LO and the air is discharged from the second bearing chamber 41. Stated otherwise, the first bearing chamber 39 and the second bearing chamber 41 function as a first gas-liquid separation unit.

In the tank 144, the air that is discharged from the first bearing chamber 39 and the second bearing chamber 41 is introduced respectively via gas discharge lines 184a and 184b, and the gas-liquid separation is carried out again. Therefore, the tank 144 functions as a second gas-liquid separation unit. The air that is discharged from the tank 144 is again separated into a gas and a liquid by the gas-liquid separator 148. Therefore, the gas-liquid separator 148 functions as a third gas-liquid separation unit.

The present embodiment possesses the following advantageous effects.

As shown in FIG. 6, the stator core 340 includes the gas supply paths 104 in order to supply the gas to the annular space 33 formed between the rotor 32 and the stator 34. The inlet 104a of the gas supply path 104 is disposed in the annular portion 342, and the outlet 104b of the gas supply path 104 is disposed at the inner end 344e of the tooth 344. In accordance with such a configuration, the air passes through the gas supply path 104 that is formed in the stator core 340, and is supplied from the inner end 344e of the tooth 344 to the annular space 33 between the rotor 32 and the stator 34. Therefore, compared to a configuration in which the air is supplied to the interior of the rotating electric machine housing 18 from a position that is separated in an axial direction away from the stator 34, a balanced supply of the air to each of the respective parts inside the rotating electric machine housing 18 can be achieved. By achieving such a balanced supply of the air, it is possible to reduce the amount of the air that is supplied.

As shown in FIG. 7, the plurality of the plate members 346 include the first plate members 346a and the second plate members 346b that are mutually different in shape from each other. The first groove portion 351 having the inlet 104a is formed in the first plate members 346a. The second groove portion 352 having the outlet 104b is formed in the second plate members 346b. The first groove portion 351 and the second groove portion 352 communicate with each other. In accordance with such a configuration, it is possible to form the gas supply path 104 in the stator core 340 without providing a through hole that penetrates from the outer end to the inner end in each of the plate members 346.

When a combination of one of the first plate members 346a and one of the second plate members 346b that are adjacent to each other is defined as one set of the composite plate units 345, the stator core 340 has a plurality of sets of the composite plate units 345. In accordance with such a configuration, a plurality of the gas supply paths 104 can be provided in accordance with the required air supply amount.

The plurality of the plate members 346 include the third plate members 346c in which the first groove portion 351 and the second groove portion 352 are not provided. By the first plate members 346a, the second plate members 346b, and the third plate members 346c being stacked in the axial direction, the gas supply path 104 is disposed in only a partial region of the stator core 340 in the axial direction. In accordance with such a configuration, the position of the gas supply path 104 can be arbitrarily designed in a manner so that the gas supply amount in the rotating electric machine system 12 becomes balanced in a desired manner.

The plurality of gas supply paths 104 are disposed mutually at intervals from one another in the circumferential direction of the stator 34. In accordance with such a configuration, the amount of the air that is supplied to the annular flow path can be made uniform in the circumferential direction.

As shown in FIG. 2, the gas flows from the outlet 104b of the gas supply path 104 in the annular space 33 toward the first bearing 38, and further, the gas also flows from the outlet 104b of the gas supply path 104 in the annular space 33 toward the second bearing 40. In accordance with this feature, without providing a sealing structure between the first bearing chamber 39 and the accommodation chamber 24 and between the second bearing chamber 41 and the accommodation chamber 24, the lubricating oil LO is prevented from flowing into the annular space 33. Therefore, as shown in FIG. 4, in (the annular gap 49) between the first bearing chamber 39 and the accommodation chamber 24, a sealing structure is not provided in order to prevent inflowing of the lubricating oil LO from the first bearing chamber 39 into the accommodation chamber 24. As shown in FIG. 5, in (the ventilation path 56) between the second bearing chamber 41 and the accommodation chamber 24, a sealing structure is not provided in order to prevent inflowing of the lubricating oil LO from the second bearing chamber 41 into the accommodation chamber 24. In accordance with such a configuration, the sealing structure (the labyrinth seal and the like) inside the rotating electric machine housing 18 can be eliminated, and thereby the structure can be simplified.

In relation to the above-described embodiment, the following supplementary notes are further disclosed.

### Supplementary Note 1

The rotating electric machine system (12) of the present disclosure includes the rotating electric machine (16) including the rotor (32) and the stator (34), the rotating electric machine housing (18) in which the rotating shaft (58) of the rotor is supported in a rotatable manner, and the first bearing (38) and the second bearing (40) configured to be interposed between the rotating electric machine housing and the rotating shaft, and to be mutually spaced apart from each other in the axial direction of the rotor, wherein the stator core (340) of the stator includes the annular portion (342) configured to constitute the outer circumferential part of the stator core, the tooth (344) configured to project out inwardly in the radial direction from the annular portion, and the gas supply path (104) in order to supply the gas into the annular space (33) formed between the rotor and the stator, the inlet (104a) of the gas supply path is disposed in the annular portion, and the outlet (104b) of the gas supply path is disposed on the inner end (344e) of the tooth. In accordance with such a configuration, the gas passes through the gas supply path that is formed in the stator core, and is supplied from the inner end of the tooth to the annular space between the rotor and the stator. Therefore, compared to a configuration in which the gas is supplied to the interior of the rotating electric machine housing from a position that is separated in an axial direction away from the stator, a balanced supply of the gas can be achieved. By achieving such a balanced supply of the gas, it is possible to reduce the amount of the gas that is supplied.

### Supplementary Note 2

In the rotating electric machine system according to Supplementary Note 1, the stator core may be constituted by stacking a plurality of the plate members (346) in the axial direction, each of the plurality of the plate members may include the outer circumferential edge part (347), and the rod shaped portion (348) that projects out in the radial direction from the outer circumferential edge part, the annular portion of the stator core may be constituted by stacking the plurality of the outer circumferential edge parts, the tooth of the stator core may be constituted by stacking the plurality of the rod shaped portions, the plurality of the plate members may include the first plate member (346a) and the second plate member (346b) having mutually different shapes from each other, the first groove portion (351) configured to constitute one part of the gas supply path and including the inlet may be formed in the first plate member, the second groove portion (352) configured to constitute one part of the gas supply path and including the outlet may be formed in the second plate member, and the first groove portion and the second groove portion may communicate mutually with each other. In accordance with such a configuration, it is possible to form the gas supply path in the stator core without providing a through hole that penetrates from the outer end to the inner end in each of the plate members.

### Supplementary Note 3

In the rotating electric machine system according to Supplementary Note 2, the a plurality of first plate members may be disposed, the plurality of second plate members may be disposed, and when the combination of one or the plurality of the first plate members and one or the plurality of the second plate members that are adjacent to each other is defined as one set of the composite plate units (345), the stator core may include the plurality of sets of the composite plate units. In accordance with such a configuration, a plurality of the gas supply paths can be provided in accordance with the required gas supply amount.

### Supplementary Note 4

In the rotating electric machine system according to Supplementary Note 2, the plurality of the plate members may include the third plate member (346c) in which the first groove portion and the second groove portion are not disposed, and by the first plate member, the second plate member, and the third plate member being stacked in the axial direction, the gas supply path may be disposed only in a partial region of the stator core in the axial direction. In accordance with such a configuration, the position of the gas supply path can be arbitrarily designed in a manner so that the gas supply amount in the rotating electric machine system becomes balanced in a desired manner.

### Supplementary Note 5

In the rotating electric machine system according to any one of Supplementary Notes 1 to 4, the plurality of gas supply paths may be disposed at intervals in the circumferential direction of the stator. In accordance with such a configuration, the amount of the gas that is supplied to the annular flow path can be made uniform in the circumferential direction.

### Supplementary Note 6

In the rotating electric machine system according to any one of Supplementary Notes 1 to 5, the rotating electric machine housing may include the accommodation chamber configured to accommodate the rotating electric machine, the first bearing chamber (39) configured to accommodate the first bearing, and to which the lubricating oil (LO) is supplied, and the second bearing chamber (41) configured to accommodate the second bearing, and to which the lubricating oil is supplied, wherein, by the gas flowing from the outlet of the gas supply path toward the first bearing in the annular space, and further, by the gas flowing from the outlet of the gas supply path toward the second bearing in the annular space, without disposing a sealing structure between the first bearing chamber and the accommodation chamber and between the second bearing chamber and the accommodation chamber, the lubricating oil may be prevented from flowing into the annular space. In accordance with such a configuration, the sealing structure (the labyrinth seal and the like) inside the rotating electric machine housing can be eliminated, and thereby the structure can be simplified.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of the operations and the order of the processes are illustrated as examples, and the present invention is not necessarily limited to these features. The same also applies to cases in which numerical values or mathematical expressions are used in the description of the aforementioned embodiments.

1. A rotating electric machine system comprising:
a rotating electric machine comprising a rotor and a stator;
a rotating electric machine housing in which a rotating shaft of the rotor is supported in a rotatable manner; and
a first bearing and a second bearing configured to be interposed between the rotating electric machine housing and the rotating shaft, and to be mutually spaced apart from each other in an axial direction of the rotor,
wherein a stator core of the stator comprises an annular portion configured to constitute an outer circumferential part of the stator core, a tooth configured to project out inwardly in a radial direction from the annular portion, and a gas supply path in order to supply a gas into an annular space formed between the rotor and the stator,
an inlet of the gas supply path is disposed in the annular portion, and
an outlet of the gas supply path is disposed on an inner end of the tooth.

2. The rotating electric machine system according to claim 1, wherein the stator core is constituted by stacking a plurality of plate members in the axial direction,
each of the plurality of the plate members comprises an outer circumferential edge part, and a rod shaped portion that projects out in the radial direction from the outer circumferential edge part,
the annular portion of the stator core is constituted by stacking a plurality of the outer circumferential edge parts,
the tooth of the stator core is constituted by stacking a plurality of the rod shaped portions,
the plurality of the plate members comprise a first plate member and a second plate member having mutually different shapes from each other,
a first groove portion configured to constitute one part of the gas supply path and including the inlet is formed in the first plate member,
a second groove portion configured to constitute one part of the gas supply path and including the outlet is formed in the second plate member, and
the first groove portion and the second groove portion communicate mutually with each other.

3. The rotating electric machine system according to claim 2, wherein a plurality of the first plate members are disposed,
a plurality of the second plate members are disposed, and
when a combination of one or the plurality of first plate members and one or the plurality of the second plate members that are adjacent to each other is defined as one set of composite plate units, the stator core comprises a plurality of sets of the composite plate units.

4. The rotating electric machine system according to claim 2, wherein:
the plurality of the plate members comprise a third plate member in which the first groove portion and the second groove portion are not disposed; and
by the first plate member, the second plate member, and the third plate member being stacked in the axial direction, the gas supply path is disposed only in a partial region of the stator core in the axial direction.

5. The rotating electric machine system according to claim 1, wherein a plurality of the gas supply paths are disposed at intervals in a circumferential direction of the stator.

6. The rotating electric machine system according to claim 1, the rotating electric machine housing comprising:
an accommodation chamber configured to accommodate the rotating electric machine;
a first bearing chamber configured to accommodate the first bearing, and to which a lubricating oil is supplied; and
a second bearing chamber configured to accommodate the second bearing, and to which the lubricating oil is supplied,
wherein, by the gas flowing from the outlet of the gas supply path toward the first bearing in the annular space, and further, by the gas flowing from the outlet of the gas supply path toward the second bearing in the annular space, without disposing a sealing structure between the first bearing chamber and the accommodation chamber and between the second bearing chamber and the accommodation chamber, the lubricating oil is prevented from flowing into the annular space.
